(19) United States
(12) Patent Application Publication
(10) Pub. No.: US 2025/0026371 A1
(43) Pub. Date: Jan. 23, 2025

(54) SYSTEMS AND METHODS FOR COOPERATIVE SENSOR FUSION BY PARAMETERIZED COVARIANCE GENERATION IN CONNECTED AUTONOMOUS VEHICLES

(71) Applicants: Edward Andert, Tempe, AZ (US); Aviral Shrivastava, Phoenix, AZ (US)

(72) Inventors: Edward Andert, Tempe, AZ (US); Aviral Shrivastava, Phoenix, AZ (US)

(21) Appl. No.: 18/777,802

(22) Filed: Jul. 19, 2024

Related U.S. Application Data
(60) Provisional application No. 63/527,778, filed on Jul. 19, 2023.

(51) Int. Cl. B60W 60/00; B60W 50/00; H04W 4/44

(52) U.S. Cl. CPC B60W 60/001; B60W 50/00; H04W 4/44; B60W 2050/0052; B60W 2556/35; B60W 2556/45

(57) ABSTRACT

A system disclosed herein applies a parameterized sensing and localization error model for use by connected devices to improve cooperative sensor fusion by estimating errors using key prediction factors (e.g., distance and velocity) at different tiers. The parameterized sensing and localization error model implements a local sensor fusion process for fusing measurements from sensors of a connected device and a global sensor fusion process for fusing measurements from many connected devices. The local sensor fusion process generates a covariance matrix that incorporates a measured distance and the global sensor fusion process generates a covariance matrix that incorporates a measured velocity combined with the local sensor fusion result. Results show an average improvement of 1.42× in RMSE vs. a typical fixed error model on a 1/10 scale test-bed.

### CROSS REFERENCE TO RELATED APPLICATIONS

This is a non-provisional application that claims benefit to U.S. Provisional Application Ser. No. 63/527,778, filed on Jul. 19, 2023, which is herein incorporated by reference in its entirety.

### GOVERNMENT SUPPORT

This invention was made with government support under 1645578 and 1723476 awarded by the National Science Foundation. The government has certain rights in the invention.

### FIELD

The present disclosure generally relates to connected autonomous vehicles, and in particular, to a system and associated method for cooperative sensor fusion by parameterized covariance generation for sensing and localization pipelines in connected autonomous vehicles.

### BACKGROUND

Cooperative sensing has been proposed to mitigate sensor coverage and obstruction issues in autonomous vehicles. Cooperative sensing occurs when multiple connected autonomous vehicles (CAVs) combine their data together to get a more accurate picture of the world around each individual CAV. Cooperative sensor fusion has been proposed to improve a number of systems in autonomous vehicle including localization and perception. Additional connected infrastructure sensors (CISs) that are placed throughout the city (such as traffic cameras) could be used to gather more data for the cooperative sensors fusion and strengthen the robustness.

Most prior works on cooperative fusion consider a fixed error model, e.g. creating a covariance matrix for sensor error using the mean error seen in all scenarios. However, assuming sensor errors to be fixed can result in poor weighting of observations in cooperative fusion.

It is with these observations in mind, among others, that various aspects of the present disclosure were conceived and developed.

### BRIEF DESCRIPTION OF THE DRAWINGS

FIG. 1 is a photograph showing a 1/10 scale CAV for development of a sensor fusion system outlined herein;

FIG. 2 is a photograph showing a 1/10 scale CIS traffic camera, LIDAR, and Nvidia Jetson camera for development of the sensor fusion system outlined herein;

FIG. 3 is a photograph showing a track in the form of a small (sₗ=1.0 m) “figure-8” loop with two CAVs and one CIS for development of the sensor fusion system outlined herein;

FIG. 4 is a diagram showing a generalized format of the track of FIG. 3 demonstrating straight length sₗ and positions for CIS devices;

FIG. 5 is a graphical representation showing longitudinal and lateral localization error components scatter plot with respect to a vehicle heading, where gray points indicate a velocity between 0.25 and 0.5 meters per second and black indicates a velocity between 0.25 and 0 meters per second;

FIG. 6 is a graphical representation showing distal error of an object detection versus distance detected to that object results in a clear correlation, where camera and LIDAR linear regression R² fitness are 0.18 and 0.35 respectively;

FIG. 7 is a diagram showing a local sensor fusion process of the sensor fusion system outlined herein that adds in a covariance generation stage using an error model for each sensor and a measured distance to generate an expected covariance matrix for each observation;

FIG. 8A is a simplified illustration showing a top-down view of an example system for implementing the framework of FIG. 7, including multiple connected devices including CAVs and CISs that communicate with an external computing platform to observe an object and fuse sensor observations to estimate a location of the object;

FIG. 8B is a simplified block diagram showing data flow between sensors of the connected device, connected devices, and the external computing platform illustrated in FIG. 8A to observe an object and fuse sensor observations to estimate a location of the object;

FIG. 9 is a diagram showing how variables are interpreted herein by illustrating a scenario where a stationary ego vehicle (a 1/10 scale CAV) is sensing two stationary objects (other 1/10 scale CAVs) many times using a camera sensor mounted at <0,0> with a facing angle of 0 degrees with respect to the ego vehicle, where the resulting point distribution is shown with an estimated 2×2 covariance matrix shown as an ellipse that was generated by our camera error estimation (note that the error distribution has been greatly exaggerated for visibility);

FIG. 10 is a graphical representation showing results of the sensor fusion system using a fixed vs. parameterized error model, where RMSE for the localization of the CAVs alone is shown as a black line-Cooperative Fusion RMSE needs to be less than this line for results to be considered more accurate than localization data alone;

FIG. 11 is a simplified diagram showing an exemplary computing system for implementation of the sensor fusion system outlined herein; and

FIGS. 12A and 12B are a pair of process flow diagrams showing a process for cooperative sensor fusion according to the framework outlined in FIGS. 7-9B.

Corresponding reference characters indicate corresponding elements among the view of the drawings. The headings used in the figures do not limit the scope of the claims.

### DETAILED DESCRIPTION

A major challenge in cooperative sensing is to weight the measurements taken from the various sources to get an accurate result. Ideally, the weights should be inversely proportional to the error in the sensing information. However, previous cooperative sensor fusion approaches for autonomous vehicles use a fixed error model, in which the covariance of a sensor and its recognizer pipeline is just the mean of the measured covariance for all sensing scenarios. A system outlined herein estimates error using key predictor terms that have high correlation with sensing and localization accuracy for accurate covariance estimation of each sensor observation. The system adopts a tiered fusion model that includes local and global sensor fusion steps. At the local fusion level, the system incorporates a covariance generation stage using the error model for each sensor based on measured distance to generate the expected covariance matrix for each observation. At the global sensor fusion level, the system incorporates an additional stage to generate the localization covariance matrix based on measured velocity and combines that with the covariance generated from the local fusion for accurate cooperative sensing. A set of 1/10 scale model autonomous vehicles with scale-accurate sensing capabilities were developed for validation of the system, with error characteristics classified against a motion capture system. Results show an average and max improvement in RMSE when detecting vehicle positions of 1.42× and 1.78× respectively in a four-vehicle cooperative fusion scenario when using the error model versus a typical fixed error model.

### I. Introduction

Cooperative sensing has been proposed to mitigate sensor coverage and obstruction issues in autonomous vehicles. Cooperative sensing occurs when multiple connected autonomous vehicles (CAVs) combine their data together to get a more accurate picture of the world around each individual CAV. Cooperative sensor fusion has been proposed to improve a number of systems in autonomous vehicle including localization and perception. Additional connected infrastructure sensors (CISs) that are placed throughout the city (such as traffic cameras) could be used to gather more data for the cooperative sensors fusion and strengthen the robustness.

Most prior works on cooperative fusion consider a fixed error model, e.g. creating a covariance matrix for sensor error using the mean error seen in all scenarios. However, assuming sensor errors to be fixed can result in poor weighting of observations in cooperative fusion. For instance, consider a scenario where two identical cameras report the distance to an object. Sensor A is 5 meters away from the object and sensor B is 200 meters away. Intuitively, the closer camera should be weighted more heavily. However, a fixed error model will not consider this problem and will weight the data the same. Consider a second scenario where vehicles A and B have a localizer that works well when traveling slow but badly at a faster speed due to a slow update frequency. The two vehicles are equidistant from an object and have the same sensor suite, but vehicle A is traveling 10× slower than vehicle B. It seems clear that the result from vehicle A should be weighted much higher than B because B will be reporting the position of the object with respect to its localization data which is less accurate. In these two scenarios, a fixed error model would weight both sensed values the same and the cooperative result may be worse than the ego vehicle sensing alone. Therefore, changes in both perception error and localization error must be taken into account when performing cooperative sensing.

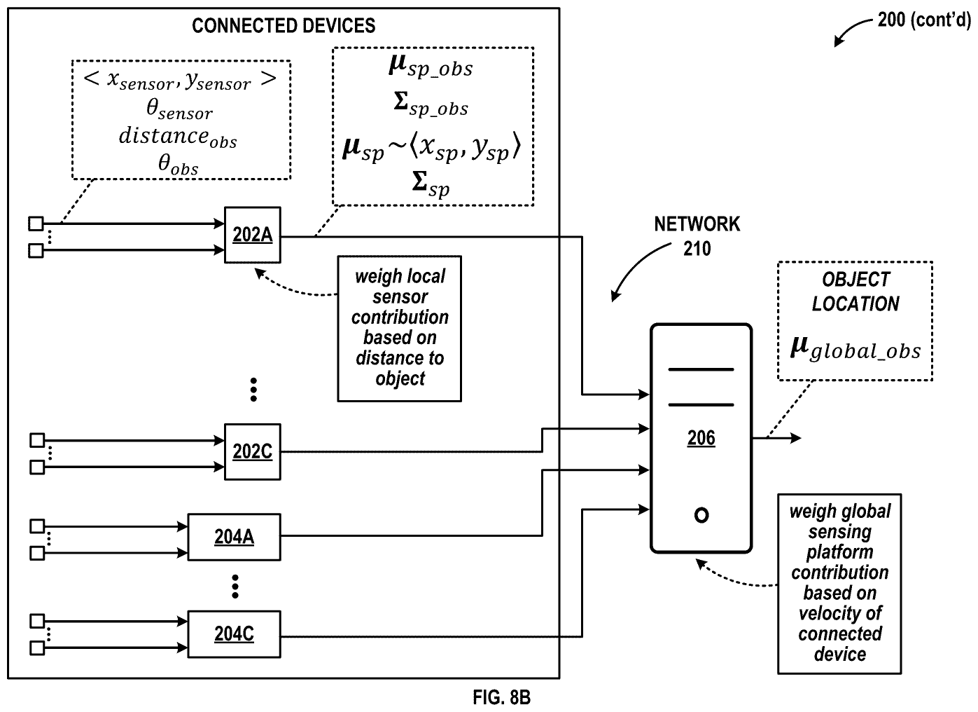

The contributions of the present disclosure include:
Analysis of error sources in autonomous vehicles. Distance from the sensor is a good predictor of sensing error, and that the velocity is a good predictor of the localization error. Using these predictors enables the generation of more accurate covariance estimation for each sensor observation.
A sensor fusion system (“framework 100” shown in FIG. 7) that adds a parameterized covariance generation step to a local fusion process based on sensor pipeline characterization that uses distance as a predictor to get a better covariance estimate, and adds a parameterized localization covariance generation using velocity as a predictor combined with local sensor fusion result to drive the global fusion step. This results in a more accurate cooperative sensing.

An in-depth analysis of a parameterized error model of the framework 100 is provided to demonstrate and evaluate the effectiveness of the framework 100. A 1/10 scale autonomous vehicle setup including of up to four CAVs and two CISs was used to implement the framework 100 and compared with a motion capture system as a baseline. Results show a significantly improvement in error fitment using the parameterized error model vs. fixed error model on the 1/10 scale setup. A high level sensor fusion pipeline is run with Joint Probability Data Association Filter (JPDA) and Extended Kalman Filter (EKF) to match and perform cooperative sensor fusion on the 1/10 scale setup using various scenario settings. The results of these tests show the parameterized error model to be 1.42× more accurate in terms of RMSE versus the motion capture system baseline across the test set and has up to a 1.78× improvement for the best case.

### II. Related Works

A previous work directed to covariance estimation techniques have used measured distance as a predictor for the <x, y> measurement covariance of a football detected by their football-playing robots. Though limited to a camera sensor modality, they showed a significant correlation with error vs. distance and that measured distance could be used as a predictor.

The present disclosure adopts the term “parameterized error model” for generating a covariance matrix using predictor terms (such as distance) to get a better fitment to the error data whereas the typical approach is to use a “fixed error model” where the covariance of a sensor and its recognizer is generated using the mean error for all sensing scenarios. This parameterized error estimation seems to have not crossed over to the autonomous vehicle field from the multi-robot field even through autonomous vehicles sensor have been shown to exhibit the same relationship. Garcia et al. (also discussed for validation of the framework 100 outlined herein) showed a significant correlation between LIDAR sensor distance measurement error with the distance to that object supporting the need for a parameterized error model. Another work showed a similar distance vs. measurement error relationship for both camera and radar detecting vehicles and how it affects Recall as well. A lone AV is likely to not notice the distance accuracy relationship as its own sensors see the same objects from a similar distance due to being mounted on the same rigid body so the problem is masked. However, this distance error relationship is very important for cooperative sensing because of the drastically different distances sensors can observe the same object from.

A further problem in cooperative fusion involving autonomous vehicles is localization error. Wan et al showed that localization error of multiple types of localizers vs. ground truth is different on the longitudinal axis of a vehicle than on the lateral axis and can be modeled using an ellipse. From the perspective a singular CAV, this localization error and its directionality is not critical. However, when moving to a cooperative sensing scenario, this localization has an additive effect because it is passed along to all observation from the CAV and is thus essential to model correctly.

Prior approaches to the problem of cooperative sensor fusion in autonomous vehicles tend to take one of three approaches for sharing data: 1) sending raw sensor data which is known as early fusion or low level sensor fusion, 2) sending object position with relevant type information and bounding box which is known as late or high level sensor fusion, and finally, 3) sending Voxel occupancy grids which the present disclosure defines as a hybrid fusion approach. The first approach can be eliminated due to well cited communication delay and scalability issues even using 802.11n in close proximity. The third (hybrid) approach can also be eliminated due to scalability problems with sending Voxel occupancy grids along with a severe accuracy vs. performance trade-offs that must be decided when choosing the size of the Voxels. The second approach (high level fusion) is selected for study because it does not suffer from communication issues and it allows for a more intuitive approach for linking sensor accuracy and modality to their respective observations.

Another work proposed a high level cooperative fusion approach using road side units and other vehicles to improve localization of an “ego” vehicle and compared this result to a DGPS baseline. Their method coined the terms “local fusion” and “global fusion” to refer to the fusion performed on sensors on-board an ego vehicle and the fusion performed on inputs from all sensors in the area respectively, both terms are also used herein. However, their results were limited to improving localization and not perception. One work compares low level and high level cooperative fusion techniques using CIS to augment the CAVs but their results do not give statistics on measurement variance and instead focus on recall in addition to using a fixed sensor error model. Another research team published a paper and an article respectively proposing high level V2X fusion method and software called C2X and providing an analysis of the results at scale using SUMO and shows the viability of high level cooperative V2X fusion at scale. However, that team used a fixed sensor error model and did not account for localization covariance. Finally, another team proposed a method for fusing heterogeneous sensors to track objects using a covariance intersection method however, this team used a fixed error model for the generation of sensor measurement and did not account for localization covariance.

### III. Experimental Setup

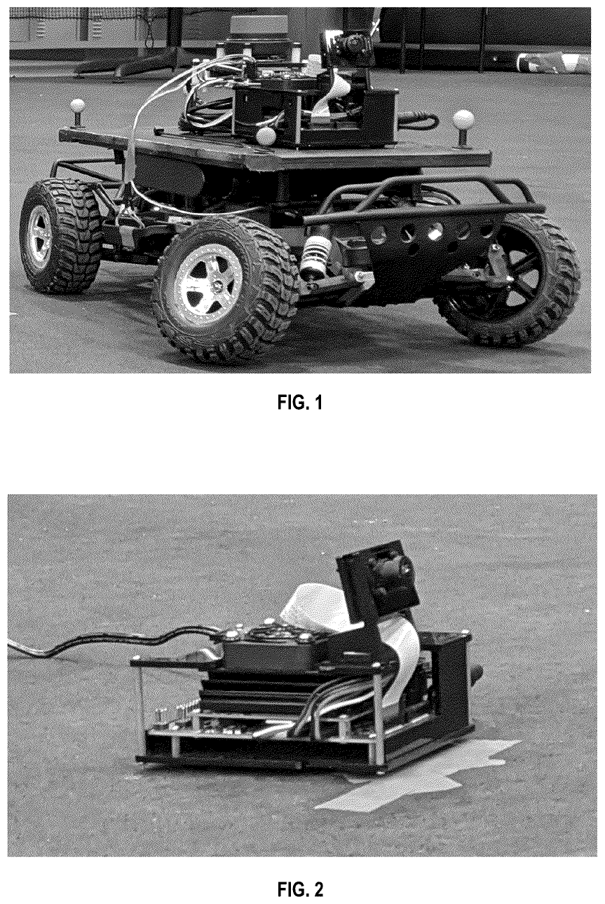

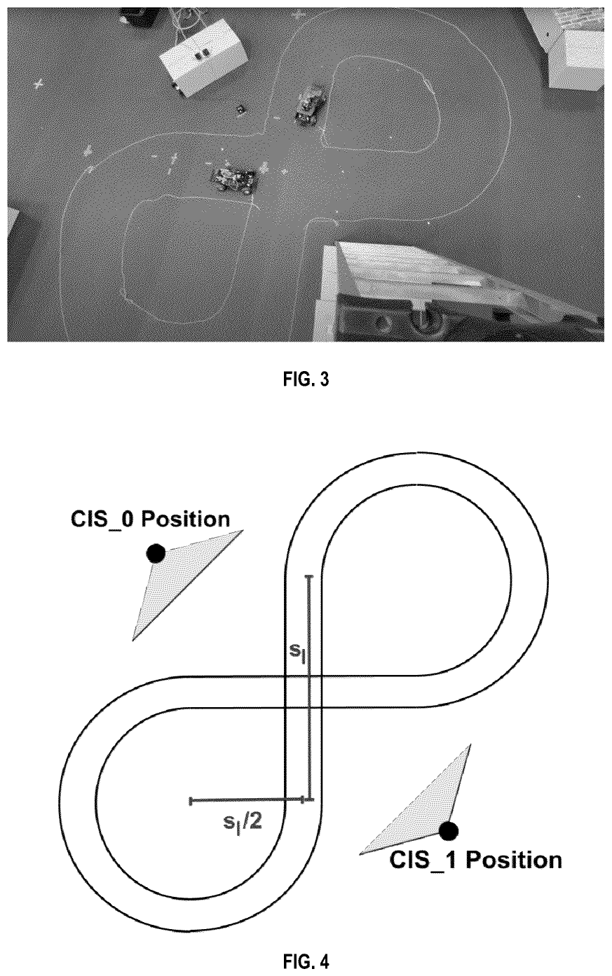

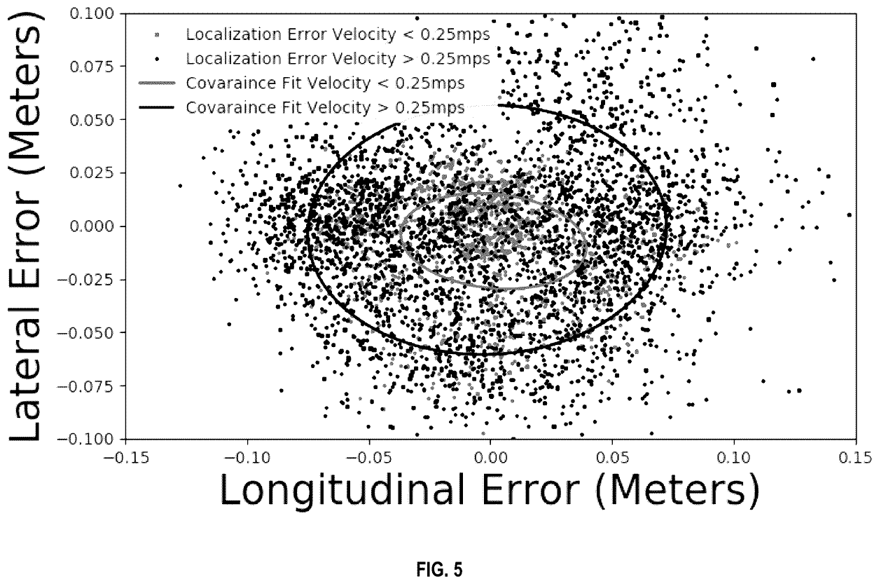

Development of the framework 100 involved analysis and characterization of various sources of error within autonomous vehicles to look for trends that can be exploited for cooperative fusion. For context, the present disclosure first outlines the experimental setup before moving on to the findings and the results. A 1/10 scale testbed shown in FIGS. 1-4 was developed with 1/10 scale vehicles, 1/10 scale road dimensions, 1/10 scale object dimensions, etc. This setup has the advantage that an Optitrack System can be used to collect the ground truth.

### A. 1/10 Scale Connected Autonomous Vehicle (CAV)

Four 1/10 scale vehicles were outfitted with scale accurate autonomous vehicles sensors including a LIDAR and camera. Sensor data was processed on-board the 1/10 scale vehicle using an Nvidia Jetson Nano 4 GB. Hardware was mounted on a Traxxis Slash 1/10 scale RWD remote control vehicle with controls of the motor and steering servo performed using a PCA9685 board connected to the Jetson Nano.

TABLE I
1/10 SCALE CAV SENSOR HARDWARE

| Type | Model | Bearing | FOV | Pipeline |
|---|---|---|---|---|
| LIDAR | Slamware M1M1 | 0° | 360° | SLAM, DBScan |
| Camera | IMX160 | 0° | 160° | YoloV4 CNN |

TABLE II
1/10 SCALE CIS SENSOR HARDWARE

| Type | Model | Bearing | FOV | Pipeline |
|---|---|---|---|---|
| Camera | IMX160 | 0° | 160° | YoloV4 CNN |

### B. 1/10 Scale Connected Infrastructure Sensor (CIS)

1/10 scale traffic cameras were implemented using Nvidia Jetson Nano and IMX160 camera used on the vehicles. The main difference in this setup from the vehicle setup is the lack of LIDAR and that fact it is a stationary platform.

### C. Camera Object Detection Pipeline

The IMX160 camera recognition pipeline included YoloV4 Tiny convolutional neural net (CNN) running natively on the Jetson Nano GPU. The CNN has been trained to recognize other 1/10 scale cars, small 1/10 scale cones, and lane corners. Distance to the object recognized by the camera is estimated using the known height of the object model, focal length of the camera, and the height detected in pixels which enables computation of the distance of the detected object. The camera recognition pipeline was run at 8 Hz to match the LIDAR.

### D. LIDAR Object Detection Pipeline

The LIDAR recognition pipeline included steps of gathering the angle and distance measurements from the LIDAR, converting to a point cloud, and using the DBScan library to cluster the points. The shape of the object was then fit to determine the distance and angle to the centroid of the vehicle point cluster.

### E. Localization Pipeline

Localization was performed via SLAM on-board the Slamtec M1M1 LIDAR along with its integrated IMU and outputted at 8 Hz. This process is proprietary, though it is known to be SLAM and works up to a velocity of 1 meter per second.

### F. Driving Scenarios

The 1/10 vehicle setup utilizes a “figure-8” route. The figure-8 is the optimal route for testing CAVs as it supplies an intersection, some straight driving, and two turns that are in the opposite direction such that there is no turn directional bias. The figure-8 is defined by the straight length, referred to herein as sₗ. The turns are of constant radius which is equal to sₗ/2. Two different figure-8 tracks were created, one where sₗ=1.0 m and the other where sₗ=2.0 m. This gives both a small and large map to test the effect of distance on sensors.

TABLE III
1/10 SCALE VEHICLE “FIGURE-8” TEST SCENARIOS

| Name | Explanation | sᵢ | CAVs | CISs |
|---|---|---|---|---|
| sm/sp | small, sparse, no CIS | 1 m | 2 | 0 |
| sm/de | small, dense, no CIS | 1 m | 4 | 0 |
| lg/sp | large, sparse, no CIS | 2 m | 2 | 0 |
| lg/de | large, dense, no CIS | 2 m | 4 | 0 |
| sm/sp/CIS | small, sparse, with CIS | 1 m | 2 | 1 |
| sm/de/CIS | small, dense, with CIS | 1 m | 4 | 2 |
| lg/sp/CIS | large, sparse, with CIS | 2 m | 2 | 1 |
| lg/de/CIS | large, dense, with CIS | 2 m | 4 | 2 |

The amount of vehicles and sensors in the figure-8 setup was intentionally varied. Two scenarios were created: a low density scenario where there is a CIS and two CAVs, and a high density scenario where there are two CISs and four CAVs. With the two track setups and two density scenarios, there were four total test setups. Presence of CIS sensors was also varied as depicted in Table III for a total of eight scenarios. These eight scenarios are believed to give reasonable coverage of the main scenarios that CAVs would encounter, light density small area, light density large area, high-density small area, and a high-density large area along with whether there are CIS sensors installed or not.

Error classification of the 1/10 scale vehicles is relatively straightforward. All of the CAVs were outfitted with Optitrack motion capture trackers. The CISs and CAVs were placed in predetermined positions with offsets between the Optitrack and Slamtec M1M1 coordinate systems zeroed out before each test. Each scenario was run for 10 minutes with the Optitrack system recording ground truth data at 120 Hz. Time synchronization was periodically performed between the Optitrack and 1/10 scale system. Data from each vehicle, sensor, and the Optitrack system was saved so it can be parsed and replayed to check for specific parameters.

### IV. Error Classification Results

### A. Velocity as a Localization Predictor

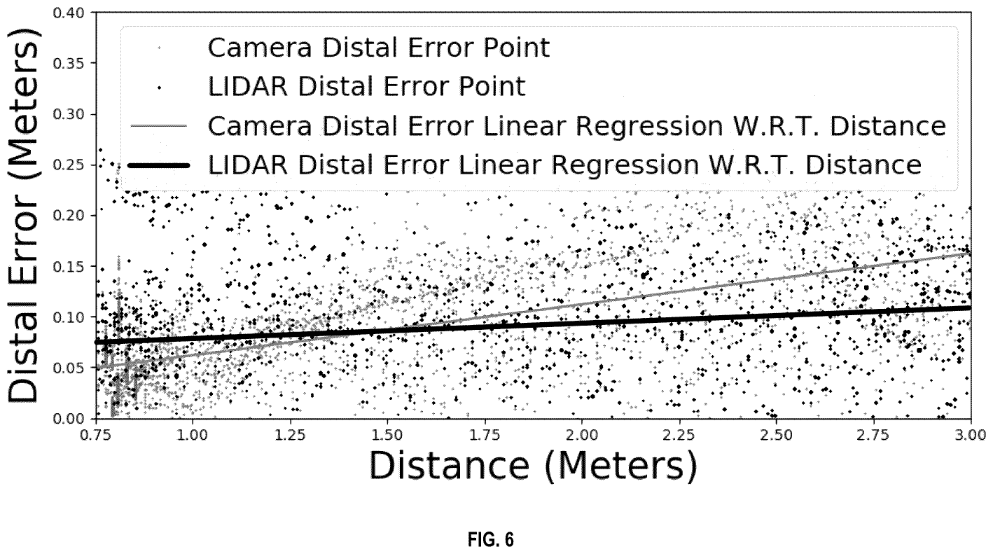

Localization accuracy is the first error classification performed. At a larger scale, this data could be latitude, longitude, and heading. In this small setup, this is a more simple x, y, yaw where a center of the figure-8 track (FIG. 4) is x=0 and y=0. Localization accuracy is measured against the motion capture system using the scenarios depicted previously.

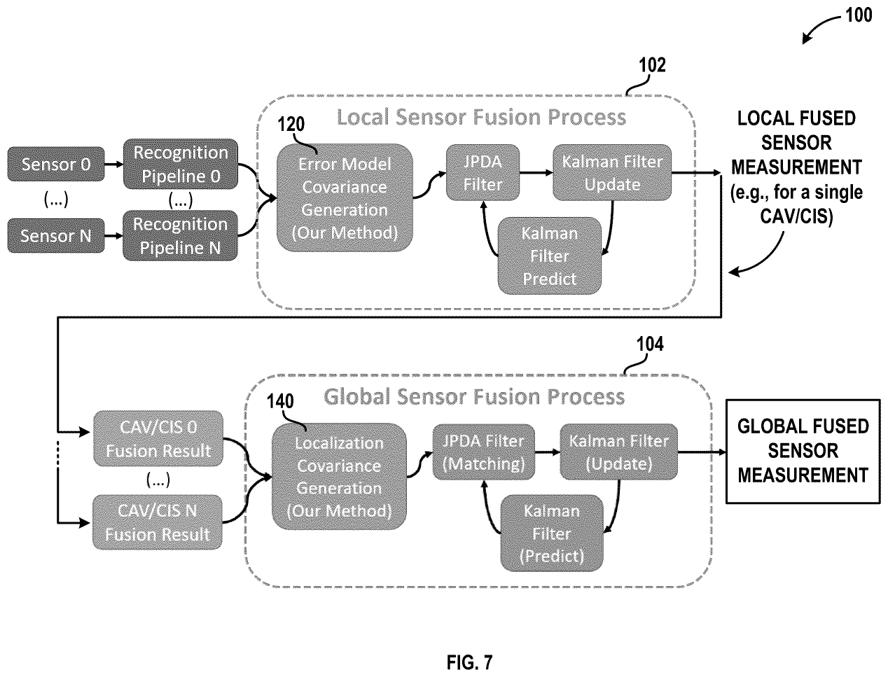

FIG. 5 shows localization error with respect to the ego vehicle direction of travel laterally (side to side) and longitudinally (front to back). The points are colored according to the velocity, black to indicate a velocity less than 0.25 meters per second, and gray to indicate the velocity is greater than 0.25 meters per second. Both sets of data are fit with a 2×2 covariance matrix using the least squares method. This results in the two ellipses in FIG. 5, the black ellipse is clustered tightly around the origin and the gray ellipse is far more spread out. These different ellipses can be explained from the stop-and-go nature of the figure-8 path. The vehicle is either maintaining the target speed, 0.5 meters per second, or is stopped or slowing for the gray traffic light and the velocity is near 0. One hypothesis that the error was Gaussian was rejected according to D'Agostino's K² test, however there is still proof that velocity is a useful predictor of variance. A linear regression fitment to the data using velocity as the X axis and expected error as the Y axis results in an R² fitment of 0.22 longitudinal error and 0.18 for lateral error. This is not a great fit, but it is significantly better than the fixed average (mean) which has an R² fitment of 0. Therefore, the analysis of localization error of the 1/10 CAVs shows that the position variance can be predicted based on measured velocity better than the mean.

### B. Distance as an Object Detection Predictor

Object detection is defined herein as the ability to detect a centroid, bounding box, and type of an object using a sensing pipeline such as camera or LIDAR. For the purposes of this disclosure, the centroid position is considered for determining object detection accuracy. Distance and angle to all objects tracked in the scene (as reported by the LIDAR and camera detection pipelines separately) are used to measure object detection accuracy. Global nearest neighbors is used to match observation to ground truth from the Optitrack system, along with human labeling where required. The distance and angle reported by the Optitrack are compared to that reported by the sensor. The results include two reported characteristics, delta distance and delta angle. This removes localization as a bias by utilizing the true position as reported by Optitrack rather than the localizer report.

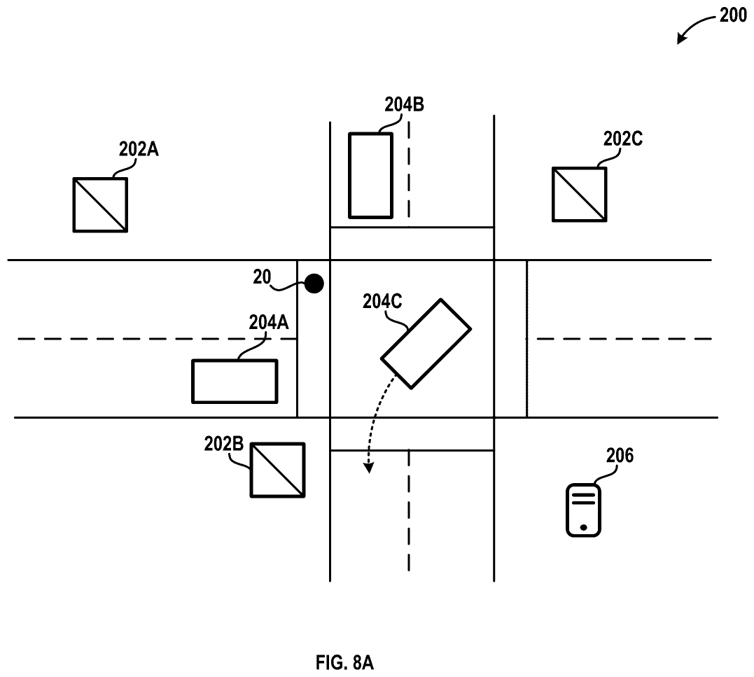

Plotting the error in distance detected to the object versus detected distance to the object in FIG. 6 shows a strong correlation. There are some artifacts at short range which come from the vehicles sitting in the same stationary location when the traffic light is gray as well as more noise for the LIDAR. It is believed this LIDAR noise is because the LIDAR pipeline is much worse than the camera at determining what is a CAV or just a random object so it may be mis-detecting the corners of boxes as other CAVs resulting in a higher rate of outliers. LIDAR error does not increase as fast as camera error and there is a distinct crossover point where the LIDAR becomes more accurate than the camera at 1.5 meters distance. The perpendicular error is not shown here but the R² is 0.021 and 0.045 for LIDAR and camera perpendicular error respectively.

### V. Cooperative Sensing Pipeline Overview

FIG. 7 shows the framework 100 that implements the parameterized sensing and localization error model discussed herein. Notably, the framework 100 implements a local sensor fusion framework 102 with a covariance generation stage 120 using an error model for each sensor and a measured distance to generate an expected covariance matrix for each observation. The framework 100 also implements a global sensor fusion framework 104 with a covariance generation stage 140 that generates a localization covariance matrix using velocity combined with a covariance generated from the local sensor fusion framework 102.

The selected approach for a sensor fusion pipeline (e.g., implementing the parameterized sensing and localization error model) of the framework 100 is tied to the decision to use high-level (late) sensor fusion. Sensors and their recognition pipelines are tied to a sensor package which is a collection of sensors mounted on the same rigid body. Two types of sensor packages are considered: 1) a connected infrastructure sensor (CIS) which could be a traffic camera or other statically mounted sensor package, and 2) a connected autonomous vehicle (CAV) which is a typical autonomous vehicle with a suitable sensor suite. All sensing platforms are assumed to include communication hardware such that they can talk to other sensor packages and roadside units (RSU) within range. Due to bandwidth constraints as well as the need for the CAV to drive using its sensor output, cooperative sensor fusion as applied by the framework 100 is done in a cascade approach. On-board each sensor package, each sensor and its respective recognition algorithm(s) processes a frame of data from the sensor and outputs a list of object observations which includes a centroid <x, y>, bounding box, and type for each observation. Local sensor fusion is performed on all on-board sensor data. Results of this local sensor fusion are transmitted to a local RSU that aggregates and fuses it with the data accessed from other CAVs and CISs in the area, and then this cooperative sensing data is distributed back out the CAVs so it can be consumed as sensing input.

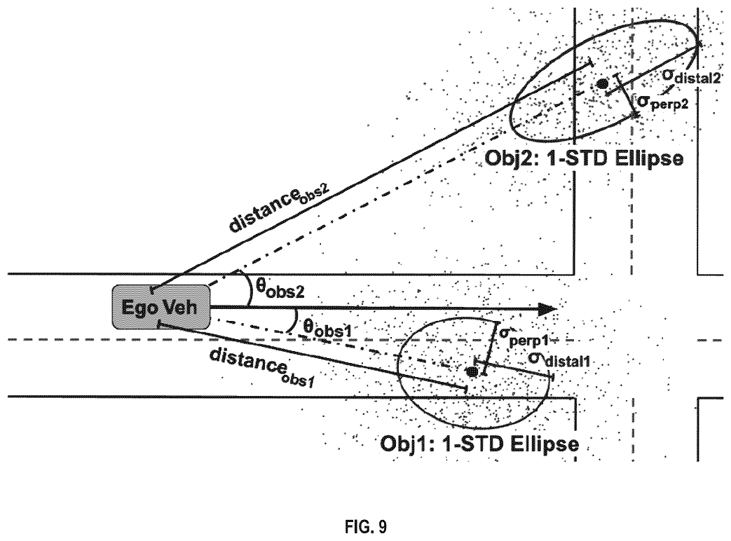

FIGS. 8A and 8B illustrate an example system 200 for implementation of the framework 100 discussed herein that includes a plurality of connected devices (including CISs 202A, 202B and 202C and CAVs 204A, 204B and 204C) that observe an object 20 and each obtain a local fused sensor measurement that represents a location of the object 20 as observed by the associated connected device (e.g., CIS 202A/202B/202C or CAV 204A/204B/204C). While the example system 200 shows three CISs and three CAVs, as well as at least two sensors for each, the framework may be applied to larger systems with any reasonable quantity of sensors on each connected device and any reasonable quantity of connected devices. Each connected device (e.g., CIS 202A/202B/202C or CAV 204A/204B/204C) accesses and locally fuses sensor observations (including sensor position <xₛₑₙₛₒᵣ, yₛₑₙₛₒᵣ>, sensor angle, θₛₑₙₛₒᵣ, observed distance distance_{obs} between the sensor and the object, and observed angle θ_{obs} between the sensor and the object) from various sensors onboard the connected device. Additionally, each connected device can report its own estimated location and angle (as_μₛₚ) and an associated sensor platform localization covariance matrix Σₛₚ for the connected device, which incorporates a velocity of the connected device to weigh contributions by the connected device.

For object observation, each connected device can obtain a local fused object location μ_{sp_obs} that represents a consensus on the object location from the plurality of sensors onboard the connected device, weighted based on a corrected localization covariance matrix Σ_{sp_obs} which can be constructed using an observation covariance matrix Σ_{obs} that incorporates errors associated with the observed distance between the sensors and the object. The corrected localization covariance matrix Σ_{sp_obs} also incorporates the sensor platform localization covariance matrix Σₛₚ and an output of a local Extended Kalman Filter (EKF) which fuses the sensor measurements.

Each connected device communicates the local fused sensor measurements and their location/velocity info to an external computing platform 206 (e.g., an RSU) over a network 210. The external computing platform 206 can use the corrected localization covariance matrix Σ_{sp_obs} to weigh contributions from individual connected devices and obtain a global fused object location μ_{global_obs} which combines local fused sensor measurements from the individual connected devices.

### VI. Local Fusion Design

FIG. 7 shows the local sensor fusion framework 102 of a single CAV or CIS. Sensors along with their recognizer are treated as separate pipelines until the JPDA filter stage where all the observations are associated using the JPDA filter. Associated observations that are considered a single object are tracked using an EKF for that track. The EKF has a “predict” stage and then up to n “update” stages (depending on how many observations from the sensor pipelines are associated with the same track).

### A. Parameterized Sensing Error Model

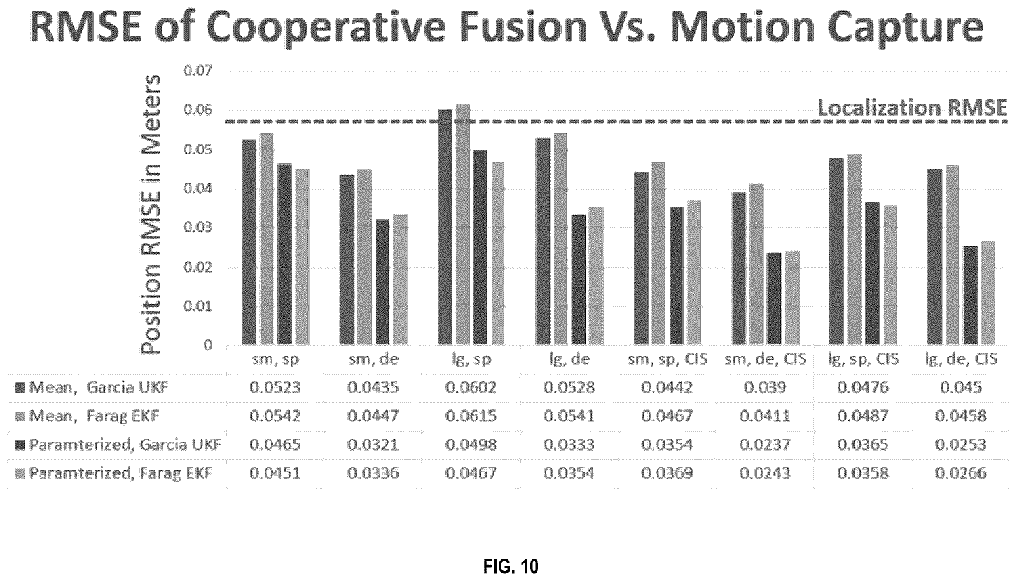

The prior section outlines observations that for the LIDAR and camera cases, measured distance as reported by the sensing pipeline was an accurate predictor of both distal and perpendicular error with respect to the sensor. A prediction equation of the covariance generation stage 120 was fit to the characterization error data. In these cases, believe a linear regression fit is believed to be accurate enough, but in some scenarios a polynomial fit could be used as well if it results in a better fit. Equation 1 shows the measurement data accessed from a sensor pipeline. Equation 2 and equation 3 show the polynomial form for the distal and perpendicular error respectively where αₖ and βₖ are the polynomial expansion coefficients that will be fit to the data using the measured distance d to the observation as a predictor. FIG. 9 provides a visual depiction of the terms used in Equations 1 through 3.

$$\begin{matrix}obs = [ \begin{matrix}{distance}_{obs} \\ {θ}_{obs}\end{matrix} ] & ( 1 ) \\ {σ}_{distal} = {\sum }_{k = 0}^{n} {α}_{k} * {distance}_{obs} & ( 2 ) \\ {σ}_{perp} = {\sum }_{k = 0}^{n} {β}_{k} * {distance}_{obs} & ( 3 )\end{matrix}$$

The distal and perpendicular errors are respectively generated by the covariance generation stage 120 using equation 2 and equation 3, with distance d measured to the observed object as a predictor. The observation position μ is calculated from the sensor position <xₛₑₙₛₒᵣ, yₛₑₙₛₒᵣ> and sensor angle θₛₑₙₛₒᵣ with respect to the ego vehicle rear axle by transforming the observed object given in equation 1 to the ego vehicle coordinate system using equations 4 and 5. The covariance of the observed object Σ_{obs} is generated using the bearing angle to the object with respect to the rear axle or ϕ_{obs} and the expected distal error and expected perpendicular error (respectively) using equation 5 and 6. This resulting <x, y> location within μ_{obs} and 2×2 covariance within Σ_{obs} are now in a form that can be easily fed into a fusion algorithm (Kalman Filter, EKF, UKF, etc.).

$$\begin{matrix}{ϕ}_{obs} = {θ}_{sensor} + {θ}_{obs} & ( 4 ) \\ {μ}_{obs} = [ \begin{matrix}{x}_{sensor} + {distance}_{obs} cos {ϕ}_{obs} \\ {y}_{sensor} + {distance}_{obs} sin {ϕ}_{obs}\end{matrix} ] & ( 5 ) \\ {Σ}_{obs} = {[ \begin{matrix}cos ( {ϕ}_{obs} ) & sin ( {ϕ}_{obs} ) \\ - sin ( {ϕ}_{obs} ) & cos ( {ϕ}_{obs} )\end{matrix} ] [ \begin{matrix}{σ}_{distal} & 0 \\ 0 & {σ}_{perp}\end{matrix} ] [ \begin{matrix}cos ( {ϕ}_{obs} ) & sin ( {ϕ}_{obs} ) \\ - sin ( {ϕ}_{obs} ) & cos ( {ϕ}_{obs} )\end{matrix} ]}^{T} & ( 6 )\end{matrix}$$

### B. Local Joint Probability Data Association Filter Design

The Joint Probability Data Association (JPDA) Filter is selected for the association of observations. Similar to García et al., each sensor observation is treated individually and is matched to the existing set of tracks. Each track has an associated EKF for fusing the observations. If an observation is not in the gate of any track and is not considered noise, then a new track will be created. To smooth out some smaller errors, a track is not officially reported until it has been tracked for a minimum amount of frames. Conversely, if a track has not had an association from a sensor observation within a specified amount of frames, that track and its associated EKF are deleted. The covariance for each observation contained in Σobs is fed into the JPDA Filter along with the observed location of the object, μ_{obs}.

### C. Sensor Platform EKF Design

All sensing pipelines are assumed to output an estimate for the μ_{obs} of each object they detect with respect to the sensor platform (e.g., CAV or CIS). The number of sensor pipelines attached to a sensor platform is not bounded. An EKF model introduced by Farag et al. (also referenced herein for benchmarking the framework 100) was modified for use within the framework 100. Using the standard form for an EKF, xₖ, Fₖ, Q, zₖ, Rₖ, and Hₖ are defined in equations 7, 8, 9, 10, 11, and 12 respectively.

$$\begin{matrix}{x}_{k} = [ \begin{matrix}x \\ y \\ v \\ ψ \\ \dot{ψ}\end{matrix} ] & ( 7 ) \\ {F}_{k} = [ \begin{matrix}1 & 0 & {F}_{{k}_{1 , 3}} & {F}_{{k}_{1 , 4}} & {F}_{{k}_{1 , 5}} \\ 0 & 1 & {F}_{{k}_{2 , 3}} & {F}_{{k}_{2 , 4}} & {F}_{{k}_{2 , 5}} \\ 0 & 0 & 1 & 0 & 0 \\ 0 & 0 & 0 & 1 & {Δ}_{t} \\ 0 & 0 & 0 & 0 & 1\end{matrix} ] , subject to Eqs . ( 8.1 ) - ( 8.6 ) & ( 8 ) \\ {F}_{{k}_{1 , 3}} = \frac{1}{ψ} ( - sin ψ + sin {Δ}_{t} \dot{ψ} + ψ ) & ( 8.1 ) \\ {F}_{{k}_{1 , 4}} = \frac{v}{\dot{ψ}} ( - cos ψ + cos {Δ}_{t} \dot{ψ} + ψ ) & ( 8.2 ) \\ {F}_{{k}_{1 , 5}} = \frac{v {Δ}_{t}}{\dot{ψ}} ( cos {Δ}_{t} \dot{ψ} + ψ ) - \frac{v {Δ}_{t}}{ψ} ( - sin ψ + sin {Δ}_{t} \dot{ψ} + ψ ) & ( 8.3 ) \\ {F}_{{k}_{2 , 3}} = \frac{1}{ψ} ( cos ψ - cos {Δ}_{t} \dot{ψ} + ψ ) & ( 8.4 ) \\ {F}_{{k}_{2 , 4}} = \frac{v}{ψ} ( - sin ψ + sin {Δ}_{t} \dot{ψ} + ψ ) & ( 8.5 ) \\ {F}_{{k}_{2 , 5}} = \frac{v {Δ}_{t}}{ψ} ( sin {Δ}_{t} \dot{ψ} + ψ ) - \frac{v {Δ}_{t}}{ψ} ( cos ψ - cos {Δ}_{t} \dot{ψ} + ψ ) & ( 8.6 ) \\ 𝒬 = [ \begin{matrix}\frac{Δ {t}^{4}}{4} {σ}_{{a}_{x}}^{2} & 0 & \frac{Δ {t}^{3}}{2} {σ}_{{a}_{x}}^{2} & 0 & 0 \\ 0 & \frac{Δ {t}^{4}}{4} {σ}_{{a}_{y}}^{2} & \frac{Δ {t}^{3}}{2} {σ}_{{a}_{y}}^{2} & 0 & 0 \\ \frac{Δ {t}^{3}}{2} {σ}_{{a}_{x}}^{2} & \frac{Δ {t}^{3}}{2} {σ}_{{a}_{y}}^{2} & Δ {t}^{2} {σ}_{a}^{2} & 0 & 0 \\ 0 & 0 & 0 & Δ {t}^{2} {σ}_{ψ}^{2} & 0 \\ 0 & 0 & 0 & 0 & Δ {t}^{2} {σ}_{ψ}^{2}\end{matrix} ] & ( 9 ) \\ {Z}_{k} = {μ}_{obs} & ( 10 ) \\ {R}_{k} = {Σ}_{obs} & ( 11 ) \\ {H}_{k} = [ \begin{matrix}1 & 0 & 0 & 0 & 0 \\ 0 & 1 & 0 & 0 & 0\end{matrix} ] & ( 12 )\end{matrix}$$

### VII. Global Fusion Design

A global cooperative sensor fusion process is applied to an area larger than an ego vehicle can see on its own, e.g., the area around a traffic light, an entire city, etc. The framework 100 implements the global sensor fusion framework 104 shown in FIG. 7 similar to local fusion. However, instead of receiving observations from a set of sensors that are hard mounted on a vehicle body, the global sensor fusion framework 104 works with outputs of the local sensor fusion framework 102 from a set of n sensor platforms which may or may not be moving. These fused sensor outputs can be treated almost the same way as the single sensor pipelines, except for one major difference; the global sensor fusion must deal with localization error.

### A. Parameterized Localization Error Model

The covariance generation stage 140 of the global sensor fusion framework 104 accounts for localization error when performing a global cooperative fusion of sensor values. Unlike on a sensor platform where the transformations between the sensors can be considered stationary because the sensors are rigidly mounted, the transformation between more than one moving sensor platform is not rigid and thus must be measured W.R.T. some shared coordinate system. Each sensor platform is assumed to have a localizer unless the platform is stationary like a CIS. For this stationary case, the CIS platform is considered to have a stationary measurement of location along with some error estimation of that measurement which will be treated the same as a localizer. A localizer regardless of type (SLAM, GPS, etc.) is assumed to report the current position of the sensor platform sp with respect to a mutual global coordinate system (e.g. latitude and longitude). The global fusion coordinate system considered by the framework 100 can be thought of as a standard x,y coordinate system where each sensor platform position is reported as <xₛₚ, yₛₚ>. This localization needs an associated error as no localizer is perfect. As discussed in the error characterization section, an accurate predictor was identified for the lateral error σₗₐₜₑᵣₐₗ and longitudinal error σ_{longitudinal} component of localization to be measured velocity νₛₚ. A polynomial is fit to the longitudinal and lateral localization error using sensor platform velocity νₛₚ as a predictor in equations 13 and 14 respectively. ηₖ and γₖ are the polynomial expansion coefficients for the longitudinal and lateral variance respectively that will be solved for.

$$\begin{matrix}{σ}_{longitudinal} = {\sum }_{k = 0}^{n} {η}_{k} * {v}_{sp} & ( 13 ) \\ {σ}_{lateral} = {\sum }_{k = 0}^{n} {γ}_{k} * {v}_{sp} & ( 14 )\end{matrix}$$

Localization error can be represented as a 2×2 matrix, with the longitudinal σ_{longitudinal} and lateral σₗₐₜₑᵣₐₗ error components estimated using the measured velocity the vehicle is traveling. This error can then be rotated based on the direction θₛₚ the vehicle is traveling. These calculations are shown in equation 16. Measured location is converted to the global coordinate system using equation 15 with the sensor platform position <xₛₚ, yₛₚ> and the position relative to the sensor platform that was generated by the local EKF state <\hat{x}_{k|k}[0], \hat{x}_{k|k}[1]> (or <x, y>).

$$\begin{matrix}{μ}_{sp \_ obs} = [ \begin{matrix}{x}_{sp} \\ {y}_{sp}\end{matrix} ] + [ \begin{matrix}{\hat{x}}_{k \vert k} [ 0 ] \\ {\hat{x}}_{k \vert k} [ 1 ]\end{matrix} ] & ( 15 ) \\ {Σ}_{sp} = {[ \begin{matrix}cos ( {θ}_{sp} ) & sin ( {θ}_{sp} ) \\ - sin ( {θ}_{sp} ) & cos ( {θ}_{sp} )\end{matrix} ] [ \begin{matrix}{σ}_{longitudinal} & 0 \\ 0 & {σ}_{lateral}\end{matrix} ] [ \begin{matrix}cos ( {θ}_{sp} ) & sin ( {θ}_{sp} ) \\ - sin ( {θ}_{sp} ) & cos ( {θ}_{sp} )\end{matrix} ]}^{T} & ( 16 )\end{matrix}$$

With the covariance of the localization known, the error is combined with the local fusion EKF error from each platform. The EKF outputs the covariance P_{k|k} but it must be rotated to the world coordinate system using equation 17. This covariance from P_{k|k} already includes the perception error that was factored in from the local fusion. The P_{k|k} covariance can be summed with the localization covariance to get an approximate covariance for that sensor fusion track combined with the expected covariance of the sensor platform localization using equation 18. This is not an exact covariance merger as it does clip some of the data that would be there with a higher-order representation. However, this is viewed as a worthwhile trade-off since our sensor fusion algorithms expects a 2×2 covariance input, thus a higher-order representation would not be usable.

$$\begin{matrix}{Σ}_{obs \_ world} = {[ \begin{matrix}cos ( {θ}_{sp} ) & sin ( {θ}_{sp} ) \\ - sin ( {θ}_{sp} ) & cos ( {θ}_{sp} )\end{matrix} ] [ \begin{matrix}{P}_{k \vert {k}_{[ 0 ] [ 0 ]}} & {P}_{k \vert {k}_{[ 0 ] [ 1 ]}} \\ {P}_{k \vert {k}_{[ 1 ] [ 0 ]}} & {P}_{k \vert {k}_{[ 1 ] [ 1 ]}}\end{matrix} ] [ \begin{matrix}cos ( {θ}_{sp} ) & sin ( {θ}_{sp} ) \\ - sin ( {θ}_{sp} ) & cos ( {θ}_{sp} )\end{matrix} ]}^{T} & ( 17 ) \\ {Σ}_{sp \_ obs} = {[ {Σ}_{sp}^{T} + {Σ}_{obs \_ world}^{T} ]}^{T} & ( 18 )\end{matrix}$$

### B. Global Fusion Incoming Message Packet Design

Global sensor fusion computations can be performed on a Road Side Unit (RSU) which is a computation platform located near the area of interest that can communicate with CAVs and CISs in the area. Data is packetized to be sent to the RSU and includes sensor platform localization (local fused object location) μ_{sp_obs}, estimated (corrected) localization covariance for Σ_{sp_obs} generated in equations 15 and 18 respectively as well as the vehicles own reported localization μₛₚ and estimated covariance Σₛₚ.

### C. Global Fusion Joint Probability Data Association Filter

The sensor platform JPDA Filter shares the same design as the one used locally on the sensor platforms. The only difference is now the sensing platforms report their observations W.R.T. a global coordinates using equation 15 and 18. This uses the same μ and σ form as the local fusion so no changes to the JPDA Filter design are necessary.

### D. Global Fusion EKF Model

The EKF for the global fusion is nearly identical to the EKF used in the local EKF. The state xₖ, update matrix Fₖ, Q, and Hₖ for the global fusion EFK is the same as those used by the local fusion EKF in equations 7, 8, 9, and 12 respectively. The zₖ and Rₖ values are modified as shown in equation 19 and 20 respectively. Just like the local fusion, the update rate is constant and the global fusion EKF has a predict stage and then up to s update stages dictated by the number of sensors packages (CAVs and CISs) there are reporting observations that are associated to the same track by the JPDA Filter. An output of the global EKF can include a global fused object location μ_{global_obs} which combines local fused sensor measurements from the individual connected devices.

$$\begin{matrix}{z}_{{k}_{sp}} = {μ}_{sp \_ obs} & ( 19 ) \\ {R}_{{k}_{sp}} = {Σ}_{sp \_ obs} & ( 20 )\end{matrix}$$

TABLE IV
1/10 SCALE SENSING EXPECTED VARIANCE EQUATIONS

| Error Type | | Parameterized | Fixed |
|---|---|---|---|
| (Direction, Sensor) | Variable | (Present Methods) | (Mean) |
| Distal, Camera | σ_{distal} | 0.0517 * d + 0.0126 | 0.0881 |
| Perpendicular, Camera | σₚₑᵣₚ | 0.0117 * d + 0.023 | 0.0401 |
| Distal, LIDAR | σ_{distal} | 0.0165 * d + 0.0607 | 0.0848 |
| Perpendicular, LIDAR | σₚₑᵣₚ | 0.0097 * d + 0.0361 | 0.0503 |
| Longitudinal, Localizer | σ_{longitudinal} | 0.0782 * v + 0.0428 | 0.0663 |
| Lateral, Localizer | σₗₐₜₑᵣₐₗ | 0.0841 * v + 0.0241 | 0.0493 |

### VIII. Cooperative Fusion Experimental Results

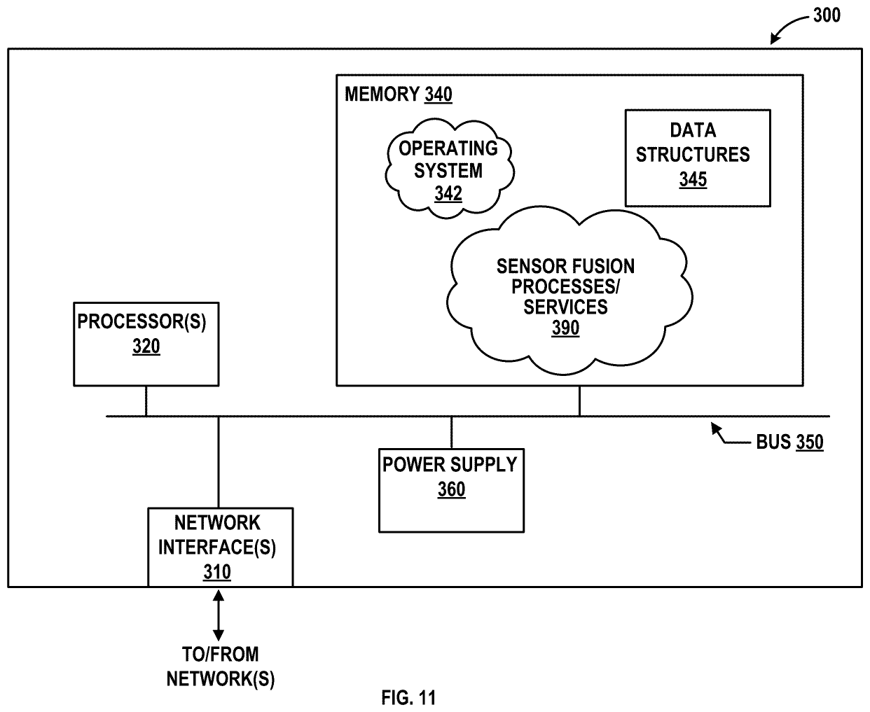

FIG. 10 shows results of the sensor fusion system using a fixed vs. parameterized error model, where RMSE for the localization of the CAVs alone is shown as a black line-Cooperative Fusion RMSE needs to be less than this line for results to be considered more accurate than localization data alone. The 1/10 scale model experiment used the map sizes and vehicle counts listed in table III. Ten-minute tests were run of the four setups depicted five times each. Data was recorded during all 20 tests so that the test set would be the same across different fusion methods. CIS sensor data was simply removed from the data-set when not needed so that makes 8 total scenarios or 40 tests. The Optitrack system was calibrated to an RMSE of 0.00088 m. Two error models are compared: 1) the parameterized error model discussed before and 2) a typical fixed error model as a baseline. The fixed error model used the mean error gathered using sensor classification for each sensing pipeline and the localization pipeline. The equations used for the parameterized error model can be found in Table IV. Two different filters are tested, the EKF outlined above from Farag et al. as well as the UKF proposed in the paper by Garcia et al., referred to as “Farag EKF” and “Garcia UKF” respectively.

A. A Fixed Error Approach can Result in Less Accurate CAV Positions than Onboard Localization Alone

RMSE localization error for the M1M1 LIDAR is 0.0576 meters. Therefore in order for the cooperative sensor fusion to return data that is useful, reported RMSE vs. the Optitrack motion capture system must be less than 0.0576 m. A major result of note is that when using a fixed model, some of the tests get an overall RMSE near 0.0576 m. This can be seen very clearly in the large sparse no CIS scenario “Is, sp” where the RMSE is 0.0602 m and 0.0615 m, which is worse than the localizer alone for both methods. The parameterized error model allows the filter to get an RMSE value that is equal or less RMSE than the localization in all cases.

### B. Connected Infrastructure Sensors are Useful Due to Lack of Localization Error

In general the larger map with the sparse setting (i.e., fewer sensors) had a higher RMSE due to the larger distances and lack of sensing. The small dense maps on the other hand have results with the lowest RMSE values. When CIS sensors are added, regardless of the fixed or parameterized model, RMSE decreases because the position of these CIS sensors is well known and does not change thus there is very little error introduced by the localization step. This makes CIS sensors very useful compared to the CAVs which have an average localization error of 0.0576 m.

C. The Parameterized Sensor Fusion Approach is More Accurate than a Fixed Approach

The most significant finding of these results is that the parameterized error model outperforms the fixed error model in every scenario. In the best case, the parameterized error model of the framework 100 along with EKF achieves an RMSE of 0.0237 m which is 2.43× better than localization was able to achieve alone and it was 1.7× better than the fixed error model in the same scenario. The results also show that the parameterized error model decreases RMSE for both the EKF and Garcia UKF models showing that it is useful for more than just one specific EKF.

### IX. Computer-Implemented System

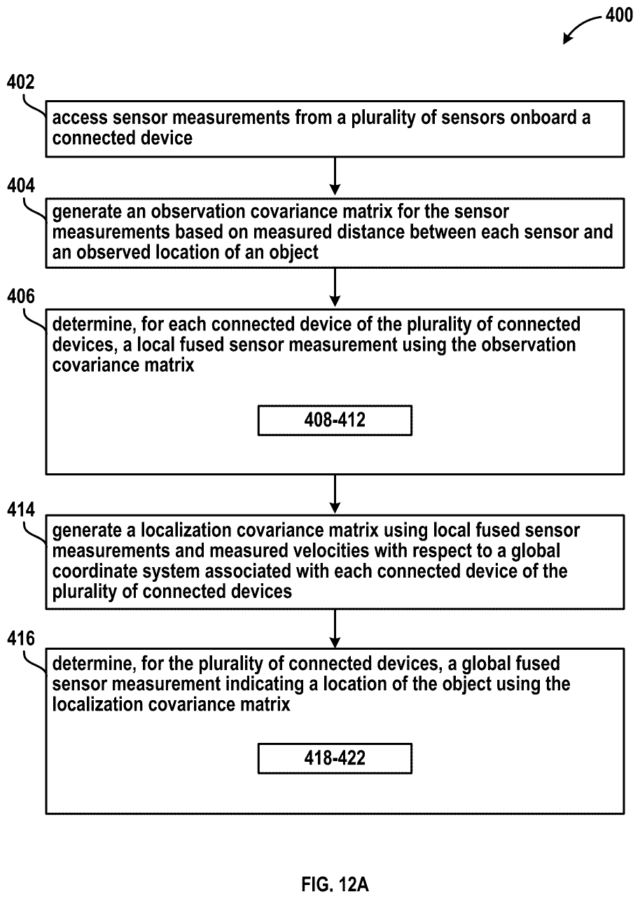

FIG. 11 is a schematic block diagram of an example device 300 that may be used with one or more embodiments described herein, e.g., as a component of framework 100 shown in FIG. 7 that aggregates and interprets local and global measurements from a plurality of CAVs and/or CISs. The example device 300 may embody a computing device onboard an individual connected device for local sensor fusion or may embody an external computing platform for global sensor fusion.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

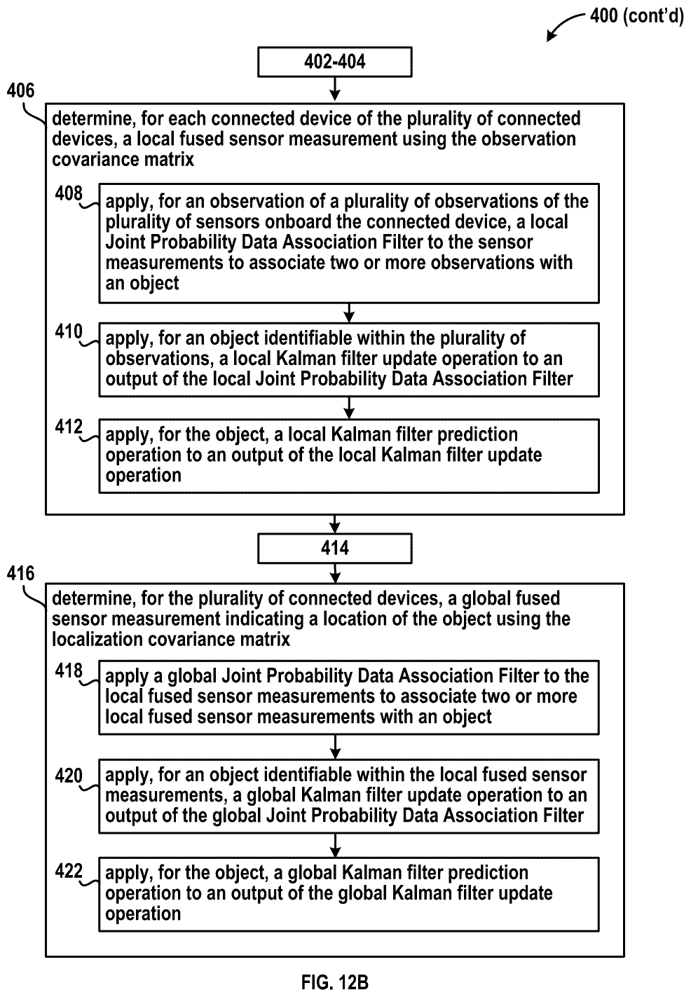

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the framework 100 and associated methods (e.g., method 400 shown in FIGS. 12A-12B) outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include sensor fusion processes/services 390, which can include aspects of the methods and/or implementations of various modules described herein. Note that while sensor fusion processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various non-transitory computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the sensor fusion processes/services 390 is shown as a standalone process, those skilled in the art will appreciate that this process may be executed as a routine or module within other processes.

### X. Computer-Implemented Method

FIGS. 12A and 12B outline a method 400 that implements aspects of the framework 100 and may be implemented using computing devices (such as computing device 300, as sensor fusion processes/services 390) onboard individual connected devices (e.g., a CAV or CIS) and onboard an external computing platform (e.g., a Road Side Unit (RSU) that communicates with the connected devices).

Step 402 of method 400 includes accessing sensor measurements for a plurality of sensors onboard a connected device, the connected device being one of a plurality of connected devices such as a connected autonomous vehicle (CAV) or a connected infrastructure sensor CIS).

The sensor measurements can be collected locally at a respective connected device which may have a plurality of sensors onboard, each with their own sensor output and their own object recognition sensing pipeline. As such, the each sensor of a plurality of sensors of the connected device can collect a plurality of local instances of (sensor-level) sensor measurements about an object of one or more objects. Each respective local instance of the sensor measurements can include:
a sensor position <xₛₑₙₛₒᵣ, yₛₑₙₛₒᵣ> of the sensor of the plurality of sensors of the connected device relative to a global coordinate system, which may also include a sensor angle θₛₑₙₛₒᵣ of the sensor of the plurality of sensors of the connected device relative to a global coordinate system;
an observed distance distance_{obs} between the sensor of the connected device and the object;
an observed angle θ_{obs} between the connected device and the object; and
an observed object location μ_{obs} of the object based on the observed sensor location μ=<xₛₑₙₛₒᵣ, yₛₑₙₛₒᵣ>, the observed distance distance_{obs}, and the observed angle θ_{obs}. In particular, the observed object location μ_{obs} is given in Eq. (5).

Step 404 of method 400 includes generating an observation covariance matrix for the sensor measurements based on measured distance between each sensor and an observed location of an object. In particular, the observation covariance matrix Σ_{obs} for the object and the sensor can be generated or otherwise constructed at the at the connected device as in Eq. (6). Importantly, the observation covariance matrix Σ_{obs} incorporates a distal error σ_{distal} and a perpendicular error σₚₑᵣₚ associated with the object and the sensor, which can each incorporate the estimated distance between the sensor of the connected device and the object for the plurality of update stages. In this way, the local fusion process (first stage) incorporates estimated distance between the object and the sensor as a predictor of accuracy which can be used to weigh contributions from individual sensors and connected devices when fusing the final results.

Step 406 of method 400 includes determining, for each connected device of the plurality of connected devices, a local fused sensor measurement using the observation covariance matrix. As expanded upon in FIG. 12B, step 406 can be divided into sub-steps 408-412 associated with fusing observations captured by multiple sensors onboard a single connected device using a local Joint Probability Data Association Filter and a local Extended Kalman filter.

Step 408 of method 400 can be considered a sub-step of step 406, and includes applying, for an observation of a plurality of observations of the plurality of sensors onboard the connected device, a local Joint Probability Data Association Filter to the sensor measurements. The local Joint Probability Data Association filter implemented by the connected device and over the plurality of update stages can associate or otherwise match two or more local instances of the sensor measurements for the object with a “track” designating the object using: the observation covariance matrix Σ_{obs} for each local instance of sensor measurements; and the observed object location μ_{obs} for each local instance of sensor measurements.

The local Joint Probability Data Association Filter serves to collect observations made by different sensor pipelines onboard the same connected device into “tracks”, where each “track” corresponds with an object. For example, many observations that collectively and consistently identify two separate objects will result in two separate “tracks”. The local Joint Probability Data Association Filter can create new tracks for observations that point to new objects, and can delete tracks for objects that are no longer being observed by the sensors. Additionally, the local Joint Probability Data Association Filter can incorporate error reduction techniques such as limiting creation of new tracks until the same object is observed over a sufficient quantity of frames, etc.

While the local Joint Probability Data Association Filter can connect observations from multiple sensors onboard the same connected device with one another, it is still necessary to: (a) fuse the sensor measurements for an object observed by the same connected device into local fused estimates; and (b) prepare for sensor fusion at the global level (e.g., for a plurality of connected devices). As such, each connected device needs to report individual localization errors which may be integrated into its local fused estimates to be sent to an external computing platform for global fusion.

Local observation fusion can be performed at the local level onboard each connected device using a local Kalman filter (or a local Extended Kalman filter). Step 410 of method 400 can be considered a sub-step of step 406, and includes applying, for an object identifiable within the plurality of observations, a local Kalman filter update operation to an output of the local Joint Probability Data Association Filter. Step 412 of method 400 can be considered a sub-step of step 406, and includes applying, for the object, a local Kalman filter prediction operation to an output of the local Kalman filter update operation to associate two or more observations with an object.

The local Extended Kalman filter implemented by the connected device can output, for the object of the plurality of objects:
a local fused object location μ_{sp_obs} of the object relative to the global coordinate system which incorporates an output state (\hat{x}_{k|k}[0], \hat{x}_{k|k}[1]> of the local Extended Kalman filter (given by Eq. (15)); and
a local fused covariance matrix P_{k|k} associated with an estimated accuracy of the output state (\hat{x}_{k|k}[0], \hat{x}_{k|k}[1]) of the local Extended Kalman filter (given as an output of the local Extended Kalman Filter).

The local fused object location μ_{sp_obs} of the object represents locally-fused observations for the object as observed by the connected device, matched together by the local Joint Probability Data Association Filter and then fused together using the local Extended Kalman filter. Note that the local Extended Kalman Filter integrates into its fusion process the observed sensor location Hobs of the object, the observation covariance matrix Σ_{obs} for the object, and a sensor platform position (xₛₚ, yₛₚ) associated with the connected device relative to the global coordinate system. Recall that the observation covariance matrix Σ_{obs} considered by the local Extended Kalman filter incorporates estimated distance between the object and the sensor as a predictor of accuracy which can be used to weigh contributions from individual sensors.

Notably, the local fused covariance matrix P_{k|k} inherently factors in “perception errors” associated with individual sensors onboard the connected device, as the local Extended Kalman filter incorporates the estimated distance between the object and the sensor as a predictor of accuracy which can be used to weigh contributions from individual sensors.

Eqs. (7)-(12) show how traditional Extended Kalman filter matrices and parameters can be modified to incorporate the observed sensor location μ_{obs} of the object (Eq. (10)) as well as the observation covariance matrix Σ_{obs} for the object (Eq. (11)) into the state estimation and uncertainty estimation, as performed by the local Extended Kalman filter onboard the connected device.

Referring back to FIG. 12A, step 414 of method 400 can include generating a localization covariance matrix using local fused sensor measurements associated with the plurality of connected devices and measured velocities of the plurality of connected devices with respect to a global coordinate system associated with each connected device of the plurality of connected devices.

Step 414 can be implemented by constructing, at the connected device, a “sensor platform” localization covariance matrix Σₛₚ for the connected device (Eq. (16)) that incorporates a longitudinal error σ_{longitudinal} and a lateral error σₗₐₜₑᵣₐₗ associated with the connected device (in addition to a sensor platform angle θₛₚ associated with the connected device relative to the global coordinate system). Importantly, the longitudinal error and the lateral error each incorporate an estimated velocity of the connected device for the plurality of update stages, given in Eqs. (13) and (14).

In this way, the global fusion process (second stage) which will eventually use the localization covariance matrix can incorporate an estimated velocity of the connected device as a predictor of accuracy which can be used to weigh contributions from individual sensors and connected devices when fusing the final results.

The localization covariance matrix Σₛₚ for the connected device given by Eq. (16) can be considered to represent a perception error that the connected device may have that can be associated with a velocity of the connected device. However, the localization covariance matrix Σₛₚ does not yet incorporate the local errors associated with the observations themselves (e.g., which rely on observed distances between the sensors and the objects as discussed above).

As such, the localization covariance matrix Σₛₚ for the connected device given by Eq. (16) must be combined with the local fused covariance matrix P_{k|k} provided by the local Extended Kalman filter (also referred to as local fusion EKF error). However, the fused covariance matrix P_{k|k} provided by the local Extended Kalman filter must be rotated to be in terms of the global coordinate system. As such, Eq. (17) shows construction of an (intermediate) observation covariance matrix Σ_{obs_world} which adjusts the local fused covariance matrix P_{k|k} provided by the local Extended Kalman filter onboard the connected device in view of the sensor platform angle θₛₚ associated with the connected device relative to the global coordinate system. The connected device can then combine the localization covariance matrix Σₛₚ for the connected device (from Eq. (16)) with the local fused covariance matrix P_{k|k} (as adjusted in Eq. (17)) into a corrected localization covariance matrix Σ_{sp_obs} for the object relative to the global coordinate system as observed by the connected device, as given in Eq. (18).

Step 416 of method 400 can include determining, for the plurality of connected devices, a global fused sensor measurement indicating a location of the object using the localization covariance matrix. Step 416 can be performed by a Road Side Unit which accesses and merges locally-fused observation data collected by the connected devices. As expanded upon in FIG. 12B, step 416 can be divided into sub-steps 418-422 associated with fusing observations captured by multiple connected devices in communication with the external computing platform using a global Joint Probability Data Association Filter (to associate instances of observation data that identify the same object with one another) and a global Extended Kalman filter (to fuse associated instances together resulting in a global fused sensor measurement that locates the object).

To enable step 416, each connected device can transmit, to an external computing platform in communication with a plurality of connected devices including the connected device, a data packet having an instance of locally-fused observation data including:
the local fused object location μ_{sp_obs} of the object relative to the global coordinate system;
the corrected localization covariance matrix Σ_{sp_obs} for the object as observed by the connected device (which incorporates;
the sensor platform position μₛₚ˜<xₛₚ, yₛₚ> associated with the connected device relative to the global coordinate system; and
the localization covariance matrix Σₛₚ for the connected device.

The external computing platform can be a Road Side Unit (RSU) which accesses a plurality of data packets from the plurality of connected devices, each data packet including an instance of locally-fused observation data for a connected device of the plurality of connected devices. The external computing platform fuses the local fused object locations from individual connected devices into the global fused sensor measurement using the locally-fused observation data provided by the plurality of connected devices.

Step 418 of method 400 can be a sub-step of step 416 and can include: applying a global Joint Probability Data Association Filter to the local fused sensor measurements (i.e., the local fusion outputs of each connected device) to associate two or more local fused sensor measurements with an object. The global Joint Probability Data Association Filter can be implemented at the external computing platform, and can be configured similarly to the local Joint Probability Data Association Filter(s) which are discussed above and implemented at individual connected devices.

The global Joint Probability Data Association filter implemented at the external computing platform can associate or otherwise match two or more (global) instances of the locally-fused observation data for the object as observed by two or more connected devices of the plurality of connected devices using:
the corrected localization covariance matrix Σ_{sp_obs} for the object as reported by each connected device of the plurality of connected devices (transmitted within the data packet to the external computing platform); and
the local fused object location μ_{sp_obs} for the object relative to the global coordinate system as reported by each connected device of the plurality of connected devices.

Like the local Joint Probability Data Association Filter, the global Joint Probability Data Association filter serves to collect observations made by different connected devices into “tracks”, where each “track” corresponds with an object. For example, many observations that collectively and consistently identify two separate objects will result in two separate “tracks”. The global Joint Probability Data Association Filter can create new tracks for observations that point to new objects, and can delete tracks for objects that are no longer being observed by the sensors. Additionally, the global Joint Probability Data Association Filter can incorporate error reduction techniques such as limiting creation of new tracks until the same object is observed over a sufficient quantity of frames, etc.

Global observation fusion can be performed at the global level onboard the external computing platform using a global Kalman filter (or a global Extended Kalman filter). Step 420 of method 400 can be a sub-step of step 416 and can include applying, for the observation, a global Kalman filter update operation to an output of the global Joint Probability Data Association Filter. Step 422 of method 400 can be a sub-step of step 416 and can include applying, for the observation, a global Kalman filter prediction operation to an output of the global Kalman filter update operation.

The global Extended Kalman filter implemented by the external computing platform can be configured similarly to the local Extended Kalman filter discussed above and can output, for the object of the plurality of objects, the global fused sensor measurement in the form of a global fused object location μ_{global_obs} of the object relative to the global coordinate system which incorporates an output state (\hat{x}_{k|k}[0], \hat{x}_{k|k}[1]> of the global Extended Kalman filter (similar to the local version outlined in Eq. (15)). For multiple objects, observation data corresponding to each “track” identified by the global Joint Probability Data Association Filter can be provided to the global Extended Kalman filter which can output the global fused sensor measurement separately for each respective object.

Different from the local Extended Kalman filter, the global Extended Kalman filter uses the local fused object location μ_{sp_obs} for the object relative to the global coordinate system (see Eq. (19)) instead of the observed sensor location μ_{obs} of the object (as in Eq. (11) for the local Extended Kalman Filter). Likewise, the global Extended Kalman filter also uses the corrected localization covariance matrix Σₛₚ obs for the object (see Eq. (20)) instead of the observation covariance matrix Σ_{obs} for the object (as in Eq. (12) for the local Extended Kalman Filter).

The global fused object location μ_{global_obs} of the object represents globally-fused observations for the object as collectively observed by the plurality of connected devices, matched together by the global Joint Probability Data Association Filter and then fused together using the global Extended Kalman filter. Note that the global Extended Kalman Filter integrates into its fusion process the local fused object location μ_{sp_obs} for the object relative to the global coordinate system as well as the corrected localization covariance matrix Σₛₚ obs for the object (as obtained by each individual connected device and provided over a network to the external computing platform).

Recall that the corrected localization covariance matrix Σ_{sp_obs} for the object considered by the global Extended Kalman filter incorporates estimated velocity of the connected devices as a predictor of accuracy which can be used to weigh contributions from individual connected devices.

Further, recall that the corrected localization covariance matrix Σ_{sp_obs} for the object that is obtained for each connected device inherently factors in “perception errors” associated with individual sensors onboard the connected device due to its incorporation of the local fused covariance matrix P_{k|k} provided by the local Extended Kalman filter (which incorporates the estimated distance between the object and the sensor as a predictor of accuracy which can be used to weigh contributions from individual sensors).

Eqs. (7)-(9), (12), (19), and 20 show how traditional Extended Kalman filter matrices and parameters can be modified to incorporate the local fused object location μsp_obs of the object (Eq. (19)) as well as the corrected localization covariance matrix Σ_{sp_obs} for the object (Eq. (20)) into the state estimation and uncertainty estimation, as performed by the global Extended Kalman filter onboard the connected device.

In some examples, the global Extended Kalman filter may also output a global fused covariance matrix P_{k|k} associated with an estimated accuracy of the output state (\hat{x}_{k|k}[0], \hat{x}_{k|k}[1]> of the global Extended Kalman filter (given as an output of the global Extended Kalman Filter).

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
one or more processors in communication with one or more memories, one or more memories including instructions executable by the one or more processors to:
access, at a connected device of a plurality of connected devices, sensor measurements from a plurality of sensors onboard the connected device;
generate, at the connected device, an observation covariance matrix for the sensor measurements based a measured distance between each sensor and an observed location of an object;
determine, for each connected device of the plurality of connected devices, a local fused sensor measurement using the observation covariance matrix;
generate a localization covariance matrix using local fused sensor measurements associated with the plurality of connected devices and measured velocities of the plurality of connected devices with respect to a global coordinate system; and
determine, at an external computing platform in communication with the plurality of connected devices, a global fused sensor measurement indicating a location of the object using the localization covariance matrix.

2. The system of claim 1, wherein the connected device is a connected autonomous vehicle having a plurality of sensors operable for generating the sensor measurements.

3. The system of claim 1, wherein the connected device includes a connected infrastructure sensor having a plurality of sensors operable for generating the sensor measurements.

4. The system of claim 1, the one or more memories further including instructions executable by the one or more processors to:
transmit, by the connected device and to the external computing platform, a data packet having an instance of locally-fused observation data, the locally-fused observation data including:
a local fused object location of the object relative to the global coordinate system;
a corrected localization covariance matrix for the object as observed by the connected device which incorporates the observation covariance matrix and the localization covariance matrix;
a sensor platform position associated with the connected device relative to the global coordinate system; and
the localization covariance matrix for the connected device.

5. The system of claim 1, the memory further including instructions executable by the processor to:
associate, at the connected device, two or more instances of the sensor measurements for the object with one another; and
fuse, at the connected device, the two or more instances of the sensor measurements for the object into the local fused sensor measurement using the observation covariance matrix.

6. The system of claim 5, the memory further including instructions executable by the processor to:
apply, for an observation of a plurality of observations of the plurality of sensors onboard the connected device, a local Joint Probability Data Association Filter to the sensor measurements to associate the two or more instances of the sensor measurements for the object with one another;
apply, for the observation, a local Kalman filter update operation to an output of a local Joint Probability Data Association Filter; and
apply, for the observation, a local Kalman filter prediction operation to an output of the local Kalman filter update operation to fuse the two or more instances of the sensor measurements for the object into the local fused sensor measurement using the observation covariance matrix.

7. The system of claim 1, the memory further including instructions executable by the processor to:
associate, at the external computing platform, two or more instances of locally-fused observation data for the object with one another; and
fuse, at the external computing platform, the two or more instances of the locally-fused observation data for the object into the local fused sensor measurement using the localization covariance matrix.

8. The system of claim 7, the memory further including instructions executable by the processor to:
apply, for an observation of a plurality of observations of the plurality of connected devices, a global Joint Probability Data Association Filter to the local fused sensor measurements to associate the two or more instances of the locally-fused observation data for the object with one another;
apply, for the observation, a global Kalman filter update operation to an output of the global Joint Probability Data Association Filter; and
apply, for the observation, a global Kalman filter prediction operation to an output of the global Kalman filter update operation to fuse the two or more instances of the observation data for the object into the local fused sensor measurement using the localization covariance matrix.

9. The system of claim 1, the localization covariance matrix incorporating the observation covariance matrix.

10. A method, comprising:
accessing at a connected device of a plurality of connected devices, sensor measurements from a plurality of sensors onboard the connected device;
generating an observation covariance matrix for the sensor measurements based a measured distance between each sensor and an observed location of an object;
determining, for each connected device of the plurality of connected devices, a local fused sensor measurement using the observation covariance matrix;
generating a localization covariance matrix using local fused sensor measurements associated with the plurality of connected devices and measured velocities of the plurality of connected devices with respect to a global coordinate system; and
determining, at an external computing platform in communication with the plurality of connected devices, a global fused sensor measurement indicating a location of the object using the localization covariance matrix.

11. The method of claim 10, further comprising:
associating, at the connected device, two or more instances of the sensor measurements for the object with one another; and
fusing, at the connected device, the two or more instances of the sensor measurements for the object into the local fused sensor measurement using the observation covariance matrix.

12. The method of claim 11, further comprising:
applying, for an observation of a plurality of observations of the plurality of sensors onboard the connected device, a local Joint Probability Data Association Filter to the sensor measurements to associate the two or more instances of the sensor measurements for the object with one another;
applying, for the observation, a local Kalman filter update operation to an output of a local Joint Probability Data Association Filter; and
applying, for the observation, a local Kalman filter prediction operation to an output of the local Kalman filter update operation to fuse the two or more instances of the sensor measurements for the object into the local fused sensor measurement using the observation covariance matrix.

13. The method of claim 10, further comprising:
associating, at the external computing platform, two or more instances of locally-fused observation data for the object with one another; and
fusing, at the external computing platform, the two or more instances of the observation data for the object into the local fused sensor measurement using the localization covariance matrix.

14. The method of claim 13, further comprising:
apply, for an observation of a plurality of observations of the plurality of connected devices, a global Joint Probability Data Association Filter to the local fused sensor measurements to associate the two or more instances of the locally-fused observation data for the object with one another;
apply, for the observation, a global Kalman filter update operation to an output of the global Joint Probability Data Association Filter; and
apply, for the observation, a global Kalman filter prediction operation to an output of the global Kalman filter update operation to fuse the two or more instances of the observation data for the object into the local fused sensor measurement using the localization covariance matrix.

15. The method of claim 10, the connected device being a connected autonomous vehicle having a plurality of sensors operable for generating the sensor measurements.

16. The method of claim 10, the connected device being a connected infrastructure sensor having a plurality of sensors operable for generating the sensor measurements.

17. The method of claim 10, further comprising:
transmitting, by the connected device and to the external computing platform, a data packet having an instance of locally-fused observation data, the locally-fused observation data including:
a local fused object location of the object relative to the global coordinate system;
a corrected localization covariance matrix for the object as observed by the connected device which incorporates the observation covariance matrix and the localization covariance matrix;
a sensor platform position associated with the connected device relative to the global coordinate system; and
the localization covariance matrix for the connected device.

18. One or more non-transitory computer-readable media including instructions executable by one or more processors to:
access, at a connected device of a plurality of connected devices, sensor measurements from a plurality of sensors onboard the connected device;
generate, at the connected device, an observation covariance matrix for the sensor measurements based a measured distance between each sensor and an observed location of an object;
determine, for each connected device of the plurality of connected devices, a local fused sensor measurement using the observation covariance matrix;
generate a localization covariance matrix using local fused sensor measurements associated with the plurality of connected devices and measured velocities of the plurality of connected devices with respect to a global coordinate system; and
determine, at an external computing platform in communication with the plurality of connected devices, a global fused sensor measurement indicating a location of the object using the localization covariance matrix.

19. The one or more non-transitory computer-readable media of claim 18, further including instructions executable by the one or more processors to:
associate, at the connected device, two or more instances of the sensor measurements for the object with one another using a local Joint Probability Data Association Filter; and
fuse, at the connected device, the two or more instances of the sensor measurements for the object into the local fused sensor measurement using the observation covariance matrix using a local Kalman filter.

20. The one or more non-transitory computer-readable media of claim 18, further including instructions executable by the one or more processors to:
associate, at the external computing platform, two or more instances of locally-fused observation data for the object with one another; and
fuse, at the external computing platform, the two or more instances of the locally-fused observation data for the object into the local fused sensor measurement using the localization covariance matrix.
